(19) United States
(12) Patent Application Publication
(10) Pub. No.: US 2022/0140712 A1
(43) Pub. Date: May 5, 2022

(54) DUAL ROTOR HOMOPOLAR AC MACHINE

(71) Applicant: Purdue Research Foundation, West Lafayette, IN (US)

(72) Inventors: Scott Sudhoff, West Lafayette, IN (US); Jiazhou Zhong, West Lafayette, IN (US); Steve Pekarek, West Lafayette, IN (US)

(73) Assignee: Purdue Research Foundation, West Lafayette, IN (US)

(21) Appl. No.: 17/515,460

(22) Filed: Oct. 30, 2021

Related U.S. Application Data
(60) Provisional application No. 63/109,606, filed on Nov. 4, 2020.

(51) Int. Cl. H02K 19/18; H02K 1/14; H02K 3/28

(52) U.S. Cl. CPC H02K 19/18; H02K 3/28; H02K 1/148

(57) ABSTRACT

A homopolar alternating current machine (HAM) is disclosed which includes a stator having a plurality of segments radially protruding outward, each segment includes a main winding, a first auxiliary winding, and a second auxiliary winding, whereby each of the first and second auxiliary windings are coupled to each other in a parallel manner, a first rotor disposed proximate the stator, a second rotor disposed proximate the stator, and a dc flux source corresponding to each of the first and second rotors, whereby substantially no excitation of the first and the second auxiliary windings of each stator segment of the plurality of segments is needed to operate the HAM, whereby when energized, there is substantially no DC flux in each of the main winding, wherein operating the HAM results in a substantially sinusoidal current waveform without a DC offset, and wherein the HAM can be operated as a motor or generator.

### CROSS-REFERENCE TO RELATED APPLICATIONS

The present patent application is related to and claims the priority benefit of U.S. Provisional Patent Application Ser. No. 63/109,606 filed Nov. 4, 2020 titled DUAL ROTOR HOMOPOLAR AC MACHINE, the contents of which is hereby incorporated by reference in its entirety into the present disclosure.

### STATEMENT REGARDING GOVERNMENT FUNDING

This invention was made with government support under DE-EE0008711 awarded by the Department of Energy. The government has certain rights in the invention.

### TECHNICAL FIELD

The present disclosure generally relates to alternating current (AC) motors/generators, and in particular, to a homopolar ac machine which can operate as a motor or a generator.

### BACKGROUND

This section introduces aspects that may help facilitate a better understanding of the disclosure. Accordingly, these statements are to be read in this light and are not to be understood as admissions about what is or is not prior art.

Nowadays AC machines used as motors or generators are ubiquitous. In particular, with the popularity of electric, hybrid, or hybrid plug-ins vehicles on a substantial rise, there is a constant demand to make these motors lighter, less expensive to manufacture all while meeting the torque density and power density demands of the vehicular market.

To date, permanent magnet alternating current (PMAC) machines have been the dominant source of motors in the car market or other markets that use AC machines. However, these machines typically utilize rare earth materials for their construction, are expensive to manufacture, while generating excellent torque densities. Non-rare earth PM machines have been realized; however, they suffer from lower torque densities. Rare earth PMs require elements, dysprosium, added to the magnet material to enable high operating temperatures which present issues of expense, market volatility, availability, and manufacturing, e.g., supply-chain. Induction machines can be used which do not have rare earth materials but do not offer the torque and power density of PM machines. Likewise, homopolar machines, eliminate or at least reduce the need for rare earth materials in their construction, however, they can rarely meet the torque density requirements in working environments.

Therefore, there is an unmet need for a novel approach in homopolar AC machines that can meet torque density requirements of demanding applications such as vehicles.

### SUMMARY

A homopolar alternating current machine (HAM) is disclosed. The HAM includes a stator having a body axially extending from a first end to a second end and further having a plurality of segments radially protruding outward from the body. Each segment includes a main winding disposed centrally about the segment, a first auxiliary winding disposed at a proximal end of the segment, and a second auxiliary winding disposed at a distal end of the segment, whereby each of the first and second auxiliary windings are coupled to each other in a parallel manner. The HAM further includes a first rotor disposed proximate the first end of the stator and a second rotor disposed proximate the second end of the stator. The HAM also includes a dc flux source corresponding to each of the first and second rotors. Substantially no excitation of the first and the second auxiliary windings of each stator segment of the plurality of segments is needed to operate the HAM. When the HAM is energized, there is substantially no DC flux in each of the main winding. Operating the HAM is associated with a substantially sinusoidal current waveform without a DC offset. The HAM can be operated as a motor or a generator.

An alternating current (AC) system for operating a homopolar AC machine (HAM) is also disclosed. The system includes a HAM. The HAM includes a stator having a body axially extending from a first end to a second end and further having a plurality of segments radially protruding outward from the body. Each segment includes a main winding disposed centrally about the segment, a first auxiliary winding disposed at a proximal end of the segment, and a second auxiliary winding disposed at a distal end of the segment, whereby each of the first and second auxiliary windings are coupled to each other in a parallel manner. The HAM further includes a first rotor disposed proximate the first end of the stator and a second rotor disposed proximate the second end of the stator. The HAM also includes a dc flux source corresponding to each of the first and second rotors. Substantially no excitation of the first and the second auxiliary windings of each stator segment of the plurality of segments is needed to operate the HAM. When the HAM is energized, there is substantially no DC flux in each of the main winding. Operating the HAM is associated with a substantially sinusoidal current waveform without a DC offset. The system also includes an interface circuit coupled to the HAM, whereby the interface circuit is adapted to operate the HAM in one of a generator or a motor, wherein the interface circuit is coupled to each of the main windings.

### BRIEF DESCRIPTION OF DRAWINGS

FIGS. 1A, 1B, 1C, and 1D are a perspective view and a partial cross-sectional views of four versions of a dual rotor homopolar alternating current machine (DHAM), according to the present disclosure.

FIG. 2 is a perspective view of another embodiment of the DHAM, according to the present disclosure.

FIG. 3 is a schematic showing flux paths in the DHAM of the present disclosure, in which the machine is shown with the rotational axis in the vertical direction.

FIG. 4 is a cross-sectional view of one embodiment of the DHAM according to the present disclosure with only field windings.

FIG. 5 is a cross-sectional view of one embodiment of the DHAM according to the present disclosure with stationary axial permanent magnets.

FIG. 6 provides performance of various versions of the DHAM configurations according to the present disclosure in a graph plotting efficiency vs. power density measured in kW/L.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

A novel approach in homopolar AC machines is presented that can meet torque density requirements of the vehicular market. Towards this end, several different Dual Rotor Homopolar AC Machines (DHAM) are presented as a novel rotating electric machine which can operate either as a motor or as a generator. Each of these versions has a novel dual rotor topology and utilizes both radial and axial flux paths. Furthermore, each of these configurations includes a segmented stator, including a plurality of segments, whereby each segment includes a main winding centrally disposed about the corresponding stator segment and two auxiliary windings each disposed on either side of the main winding. In each case, there is a DC flux source incorporated into the machine. The DC flux source may be a set of permanent magnets (rare earth or non-rare earth permanent magnets), or alternatively a field winding disposed about the stator body but corresponding to each rotor. In either case, each rotor includes said DC flux source. In the permanent magnets case, the permanent magnets can be coupled to a corresponding rotor and thus rotate as the rotor rotates. Alternatively, in the case of field windings, the field winding is mounted between each rotor and the stator body and is thus stationary. These six versions include: 1) a stationary permanent magnet version, whereby each permanent magnet is decoupled from a corresponding rotor and thus is stationary with respect to the rotor, 2) a rotating PM machine, whereby each permanent magnet is coupled to the corresponding rotor and thus configured to rotate with the rotor, 3) a field winding version whereby the permanent magnets are replaced with field windings that are positioned between the stator body and a corresponding rotor in a stationary manner. Each of the above versions can be presented with a segmented stator that has A) uniform stator segments; and B) short and long stator segments, making up the six versions. It should be noted that various embodiments for the permanent magnets are possible, e.g., a superconducting puck, as discussed below.

Where permanent magnets are used, the permanent magnets can have heavy-rare-earth materials, with atomic numbers ranging from 62-71, which includes dysprosium, in combination with other materials. Many commonly used neodymium iron boron magnets include dysprosium, and are thus considered heavy-rare-earth. Alternatively, the permanent magnets may be constructed from non-heavy-rare-earth material that is selected from the group consisting of Nd₂Fe₁₄B, AlNiCo, ferrite, PtCo, MnAlC, and a combination of one or more thereof.

There are several different windings: the main windings and auxiliary windings. The power transfer to the machine is through the main windings of the machine which constitute three or more phases. Nominally, a three-phase system is employed for the main windings, although any number of phases greater than two could be used. The voltage and current waveforms associated with the main windings are nominally sinusoidal, and the torque produced by the machine is nominally constant. Unlike other homopolar machines, the flux through the main winding does not have a dc bias leading to better material utilization.

The auxiliary windings of the machine (there are two: upper and lower), are coupled together in parallel as the voltage across the two windings is substantially identical, while the required currents are opposite. The local connection between terminals of the auxiliary windings on each stator segment is as follows: if the auxiliary windings are wound in the same manner (i.e., both are wound clockwise or both are wound counterclockwise), then the top and bottom terminals of the top auxiliary winding are coupled to the top and bottom terminals of the bottom auxiliary winding, respectively. If however, the two auxiliary windings are wound opposite one-another, then the top and bottom terminals of the top auxiliary winding are coupled to the bottom and top terminals of the bottom auxiliary winding, respectively Alternatively, the auxiliary windings can be terminaled (i.e., end of each auxiliary winding can be brought out to a corresponding terminal for excitation) outside the machine, for situations in which minute excitation of the auxiliary windings is desirable. Thus, as a whole, little or no excitation of the auxiliary winding is required. The role of the auxiliary winding is to distribute the flux in the desired fashion, which in turn allows the same amount of average power to be delivered to the main windings with a lower peak and rms phase currents for the same peak voltage than would otherwise be possible (which is analogous to operating at a higher power factor).

The novel DHAM configuration of the present disclosure provides several advantages: 1) The field winding in the case of field-wound type (or the permanent magnets in the case of permanent magnet type, or the use of a superconducting puck, in leu of a permanent magnet) can be stationary. This facilitates cooling, electrical connections to the field, and eliminates mechanical stresses on the field winding in high speed machines. This features also facilitates the use of superconducting field windings, if desired. For low speed machines, the magnets can be placed on the rotor and allowed to rotate, if desired. In this configuration, there is still an advantage in that the magnets are at a smaller radius than the teeth and thus experience less force, and are more easily structurally wrapped than in traditional machines since flux is not crossing a radial airgap in this region. 2) The rotors themselves are nominally lossless, which also facilitates high speed applications in that the machine can be run in a vacuum. 3) The stator structure is segmented, facilitating manufacturing, leading to a high packing factor, as well as facilitating the construction of large machines. 4) The stator structure is easy to wind. This facilitates high winding packing factor helps reduce the size of the machine and improves thermal transfer. 5) The DHAM according to the present disclosure has a wide constant power speed range. This feature advantageously makes it ideal for applications such as flywheel energy storage and electric vehicles. 6) Owing to a compact architecture, space within the machine is available for the inverter allowing one assembly of the machine and inverter in a single package. Additionally benefits of the DHAM and its various embodiments according to the present disclosure includes AC machines with stationary windings (i.e., non-rotating windings), provides large constant power speed range, and owing to its simplicity can be readily manufactured (even more easily than induction machines).

Another additional benefit of the DHAM of the present disclosure is that in the PM variety, the permanent magnets are placed in specific locations in the machine where it will see less field variation and so have less eddy currents and thus the associated heating. This also facilitates the use of superconducting windings or a superconducting puck for some applications. Thus, the thermal issues seen in PMACs do not pose a challenge. In addition, the DHAM of the present disclosure can use stationary magnets allowing them to be more easily cooled, advantageously eliminating the necessity of high temperature material selection, e.g., dysprosium, and also further avoid mechanical stresses of rotating high speeds.

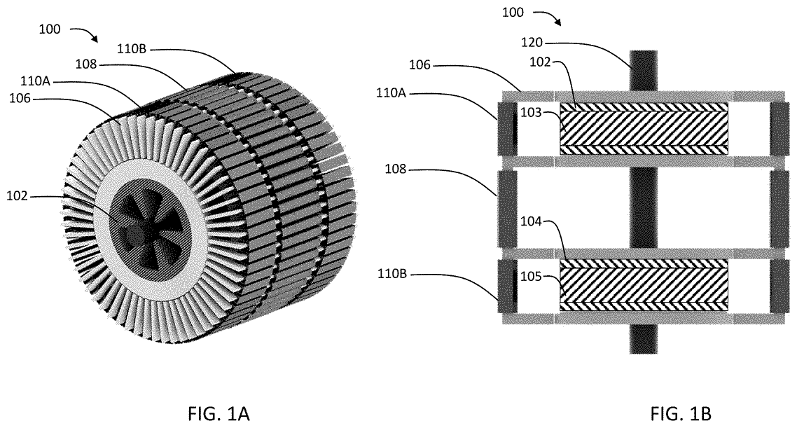

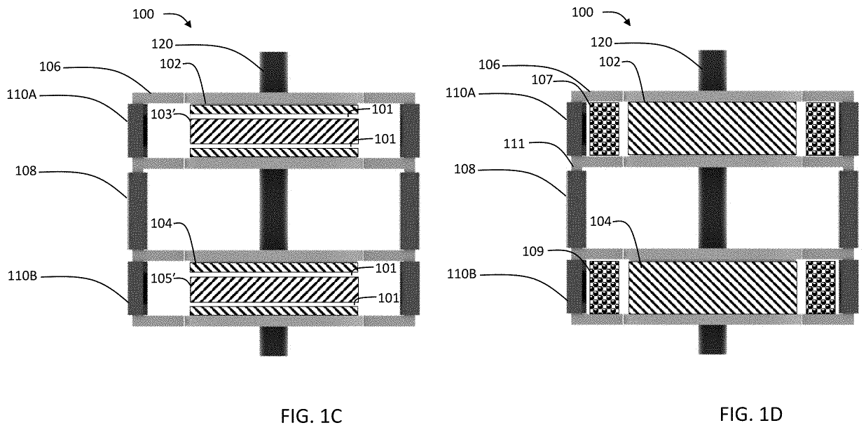

Referring to FIGS. 1A, 1B, 1C, and 1D, a perspective view and partial cross-sectional views of the four versions of the DHAM 100 according to the present disclosure are provided. The DHAM 100 includes two rotors 102 and 104 (the second rotor 104 is shown in FIG. 1B) and a segmented stator 106. Permanent magnets 103 and 105 are coupled to the rotors 102 and 104, respectively, and are configured to rotate with the rotors 102 and 104. The segmented stator 106 shown in FIG. 1A includes a plurality of segments each of substantially the same configuration and dimensions. Disposed on each of these segments are primary windings 108 and auxiliary windings 110A and 110B. A driveshaft 120 is also depicted passing through the two rotors 102 and 104.

Referring to FIG. 1C, another version of the DHAM 100 is shown whereby the permanent magnets 103′ and 105′ are decoupled from their corresponding rotors 102 and 104, respectively, and are thus configured to be stationary. Each permanent magnet 103′ and 105′ is decoupled from the corresponding rotor 102 and 104 by placing a gap 101 therebetween.

Referring to FIG. 1D, another version of the DHAM 100 is shown whereby field windings 107 and 109 are disposed between each of the two rotors 102 and 104 and the stator body 111.

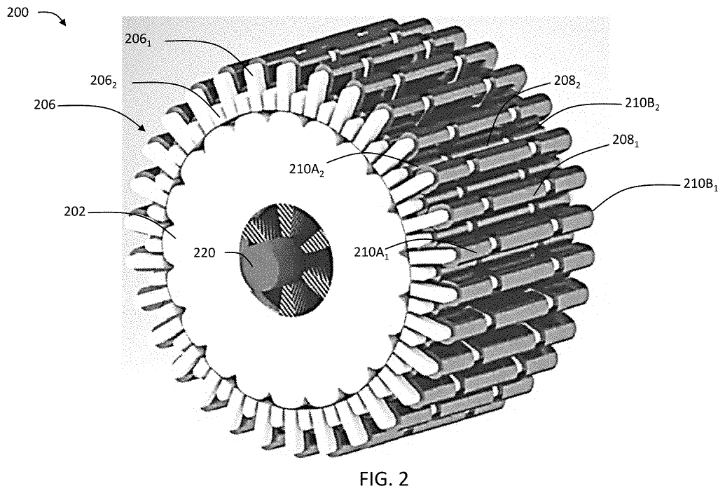

Referring to FIG. 2, a perspective view of another embodiment of the DHAM 200 according to the present disclosure is provided. In this embodiment, the DHAM 200 is similarly constructed as the DHAM 100 shown in FIGS. 1A and 1B (that is, the DHAM 200 includes two rotors 202 and 204 (the second rotor 204 is on the backside and thus hidden), a segmented stator 206 with a plurality of segments, and disposed on these segments are primary windings and auxiliary windings); however, unlike the DHAM 100 shown in FIGS. 1A and 1B, the DHAM 200 shown in FIG. 2 has a stator 206 which includes a plurality of segments having two varieties of dimensions, each of which having substantially the same configuration and dimensions. These segments are called out as 2061 having a larger outward dimension, and 2062 having a smaller outward dimension. On these segments 2061 and 2062 are main windings 2081 and 2082 and auxiliary windings 210A1 and 210A2 and 210B1 and 210B2. The arrangement shown in FIG. 2, can advantageously be used to increase torque density for situations where there are a large number of segments thus allowing making the stator segments to be packed closer together. Essentially, the arrangement shown in FIG. 2 allows fitment of more segments around the machine since the windings do not overlap one-another.

As discussed above, regardless of which configuration (i.e., the DHAM 100 shown in FIGS. 1A and 1B or the DHAM 200 shown in FIG. 2), the exemplary auxiliary windings (i.e., 110A and 110B of the DHAM 100 or 210A1, 210B1, 210A2, and 210B2 of the DHAM 200), are coupled together in parallel thus making the voltage across the two windings to be substantially identical, while the required currents are opposite, resulting in little or no excitation of the auxiliary winding.

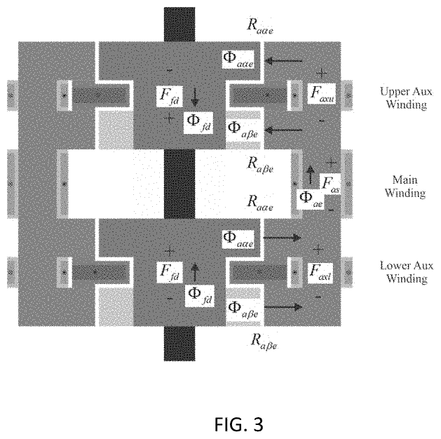

To better elucidate the working principals of the DHAM according to the present disclosure, reference is made to FIG. 3 which is a schematic showing flux paths in the machine, in particular, shows the machine with the rotational axis in the vertical direction. The mechanical rotor position is denoted in FIG. 3 as θₘ, while the electrical rotor position is defined as

$${θ}_{r} = \frac{{R}_{P}}{2} {θ}_{rm} \qquad ( 1 )$$

wherein Rₚ is the number of rotor poles. For each phase, there are two sets of rotor teeth, the alpha teeth and the beta teeth. The reluctances between the rotor and the alpha teeth are expressed as:

R_{aαe}=R_{Ae}−R_{Be} sin(2θᵣ) (2)

R_{bαe}=R_{Ae}−R_{Be} sin(2θᵣ+2π/3) (3)

R_{cαe}=R_{Ae}−R_{Be} sin(2θᵣ−2π/3) (4)

The reluctances between the rotor and the beta teeth are expressed:

R_{aβe}=R_{Ae}+R_{Be} sin(2θᵣ) (5)

R_{bβe}=R_{Ae}+R_{Be} sin(2θᵣ+2π/3) (6)

R_{cβe}=R_{Ae}+R_{Be} sin(2θᵣ−2π/3) (7)

where R_{Ae} and R_{Be} are constants. The final ‘e’ in the subscript stands for ‘effective’ in the sense of being a parallel combination of all rotor poles. In particular,

$$\begin{matrix}{R}_{Ae} = \frac{{R}_{A}}{{R}_{P}} & ( 8 ) \\ {R}_{Be} = \frac{{R}_{B}}{{R}_{P}} & ( 9 )\end{matrix}$$

Having defined the reluctances, torque may be expressed as:

$${T}_{e} = - \frac{1}{2} {R}_{P} ( \begin{matrix}{Φ}_{a α e}^{2} \frac{\partial {R}_{a α e}}{\partial {θ}_{r}} + {Φ}_{a β e}^{2} \frac{\partial {R}_{a β e}}{\partial {θ}_{r}} + \\ {Φ}_{b α e}^{2} \frac{\partial {R}_{b α e}}{\partial {θ}_{r}} + {Φ}_{b β e}^{2} \frac{\partial {R}_{b β e}}{\partial {θ}_{r}} + \\ {Φ}_{c α e}^{2} \frac{\partial {R}_{c α e}}{\partial {θ}_{r}} + {Φ}_{c β e}^{2} \frac{\partial {R}_{c β e}}{\partial {θ}_{r}}\end{matrix} ) \qquad ( 10 )$$

where the flux terms are depicted in FIG. 3, and each of these terms represents the total flux in magnetically parallel legs.

Next, is to develop mathematical relationship that describe control of the flux in the phase legs. The alpha leg fluxes are described as:

Φ_{aαe}=Φ_{dc}+Φ_{ac} cos(2θᵣ+ϕ) (11)

Φ_{bαe}=Φ_{dc}+Φ_{ac} cos(2θᵣ+ϕ+2π/3) (12)

Φ_{cαe}=Φ_{dc}+Φ_{ac} cos(2θᵣ+ϕ−2π/3) (13)

The beta leg fluxes are described as:

Φ_{aβe}=−Φ_{dc}+Φ_{ac} cos(2θᵣ+ϕ) (14)

Φ_{bbe}=−Φ_{dc}+Φ_{ac} cos(2θᵣ+ϕ+2π/3) (15)

Φ_{cβe}=−Φ_{dc}+Φ_{ac} cos(2θᵣ+ϕ−2π/3) (16)

It should be noted that φ_{dc} and Φ_{ac} are constants for a given operating point describing the dc and ac amplitude of the flux, as well as the quantity ϕ is also a constant for a given operating point.

Substitution of the reluctance profiles according to equations 2-7 and the desired fluxes expressed by equations 11-16, the electromagnetic torque may be expressed as:

Tₑ=6RₚR_{Be}Φ_{dc}Φ_{ac} cos ϕ (17)

As indicated by equation 17, the torque is proportional to the product of Φ_{dc} and Φ_{ac}, and is, ideally, constant, thus expressing an advantageous and desirable property of the DHAM according to the present disclosure.

Next consideration is the flux through the main winding (e.g., 108 of FIGS. 1 and 208 of FIG. 2). The flux through the main winding is given by:

Φₐₑ=Φ_{aαe}+Φ_{aβe} (18)

Substituting equations 11 and 14 into equation 18, provides the following relationship:

Φₐₑ=2Φ_{ac} cos(2θᵣ+ϕ) (19)

From equation 19, the main component of the voltage across one of the a-phase legs is given

$${v}_{as} = \frac{- 4 N {Φ}_{ac} {ω}_{r}}{{R}_{P}} sin ( 2 {θ}_{r} + ϕ ) \qquad ( 20 )$$

which shows another desirable property of the DHAM—that is, the DHAM of the present disclosure is fundamentally, a sinusoidal voltage machine.

Having derived the voltage relationship, next current relationships in each of the main windings is derived. Referring to FIG. 3, the MMF associated with an a-phase phase leg is given by

Fₐₛ=R_{aαe}Φ_{aαe}+R_{aβe}Φ_{aβe} (21)

The relationship expressed in equation 21 takes advantage of the fact that there is a virtual magnetic core (i.e. no MMF drop) between the two rotors. Substituting equation (2), (5), (11), and (14) into (21) provides

Fₐₛ=Niₐₛₗ=2R_{Ae}Φ_{ac} cos(2θᵣ+ϕ)−2R_{Be}Φ_{dc} sin(2θᵣ) (22)

whereas iₐₛₗ is the current in one a-phase stator leg. From equation 22, another attractive feature of the DHAM can be observed according to the present disclosure—that the current waveform is also sinusoidal.

After having considered the main windings, reference is now made back to FIG. 3 as it relates to auxiliary windings. Referring to FIG. 3, the MMF needed in the upper and lower auxiliary windings is given by

Fₐₓᵤ=Niₐₓᵤ=R_{aαe}Φ_{aαe}−R_{aβe}Φ_{aβe}−F_{fd} (23)

Fₐₓₗ=Niₐₓₗ=−R_{aαe}Φ_{aαe}+R_{aβe}Φ_{aβe}+F_{fd} (24)

It can be concluded that We conclude that the current need in the upper and lower auxiliary windings is equal in magnitude and opposite in sign; thus, iₐᵤₓ=−iₐₓₗ.

It is further observed that substitution of equations (2), (5), (11), and (14) into (23) and (24) results in:

Fₐₓᵤ=−F_{fd}+2R_{Ae}Φ_{dc}+R_{Be}Φ_{ac} sin ϕ−R_{Be}Φ_{ac} sin(4θᵣ+ϕ) (25)

Fₐₓₗ=F_{fd}−2R_{Ae}Φ_{dc}−R_{Be}Φ_{ac} sin ϕ+R_{Be}Φ_{ac} sin(4θᵣ+ϕ) (26)

Substituting field MMF expressed below in (27) in (25) and (26) the expression for the control winding MMFs will then be provided in (28) and (29):

F_{fd}=2R_{Ae}Φ_{de}+R_{Be}Φₐₑ sin ϕ (27)

Fₐₓᵤ=−R_{Be}Φ_{ac} sin(4θᵣ+ϕ) (28)

Fₐₓₗ=R_{Be}Φ_{ac} sin(4θᵣ+ϕ) (29)

From these relationships it can be seen that the control winding currents are purely sinusoidal with no DC offset as expressed below:

$$\begin{matrix}{i}_{axu} = - \frac{{R}_{Be} {Φ}_{a c}}{N} sin ( 4 {θ}_{r} + ϕ ) & ( 30 ) \\ {i}_{axl} = \frac{{R}_{Be} {Φ}_{ac}}{N} sin ( 4 {θ}_{r} + ϕ ) & ( 31 )\end{matrix}$$

The voltages across the auxiliary windings of one leg are given by

$$\begin{matrix}{v}_{axu} = \frac{N}{{R}_{P}} \frac{d {Φ}_{a α e}}{dt} & ( 32 ) \\ {v}_{axl} = \frac{N}{{R}_{P}} \frac{d {Φ}_{a β e}}{dt} & ( 33 )\end{matrix}$$

Since the ac component of Φ_{aαe} is equal to the ac component of Φ_{aβe} as observed from equations (11) and (14), their time derivatives are equal, and hence the auxiliary winding voltages need to be equal, that is νₐₓᵤ=νₐₓₗ. If the auxiliary windings are viewed as a pair, since their voltages are the same, their currents need to be opposite. In essence, this can be achieved by simply tying the two coils together and allowing the coils to be self-excited. Thus no further excitation is necessary. One way of looking at this is that by tying the auxiliary winding together, use of Lenz's law to ensures that equal ac parts are present, similar to a current transformer. Thus, advantageously there is no need to drive another set of windings, resulting in a major benefit of the DHAM of the present disclosure.

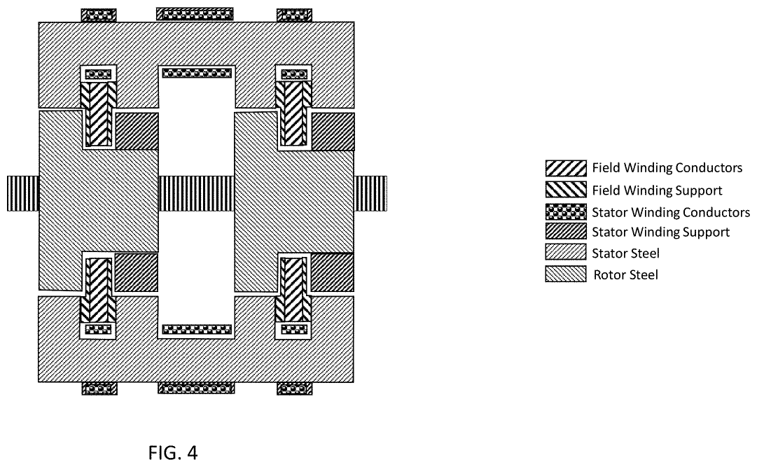

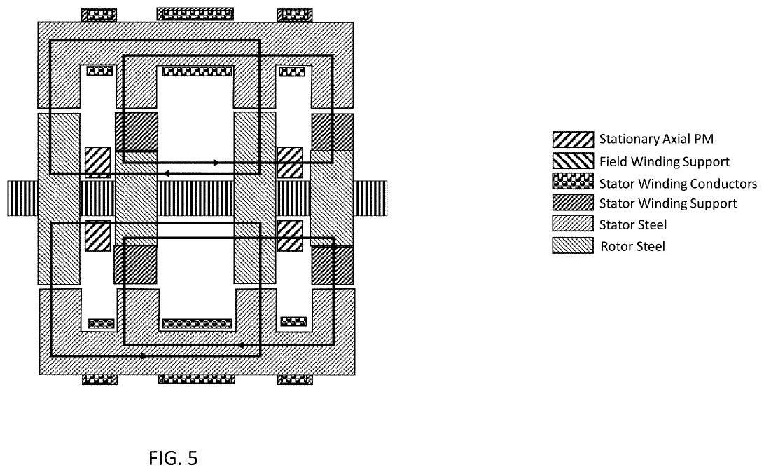

Referring to FIG. 4, a cross-sectional view of the DHAM according to the present disclosure are provided with only field windings. Similarly, referring to FIG. 5, another cross-sectional view of the DHAM according to the present disclosure are provided with stationary axial permanent magnets.

The interleaved stator arrangement (i.e., the stator 206 of the DHAM 200, shown in FIG. 2) drastically improves the power density, which has been shown to surpass that of a permanent magnet AC (PMAC) machine.

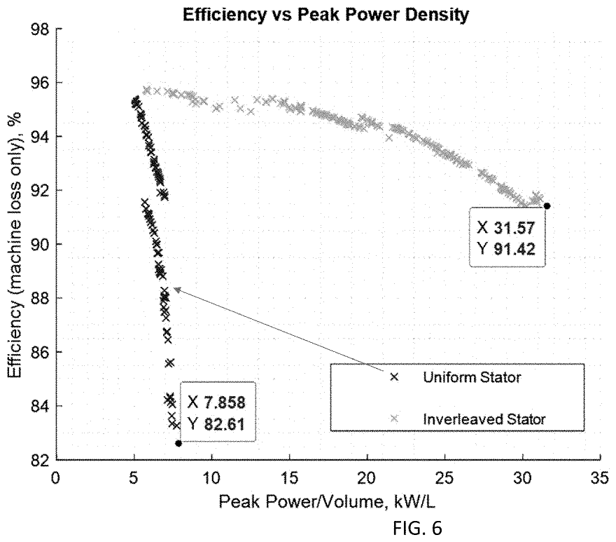

The DHAM configuration shown in FIG. 2, provides significant improvements over other DHAM configurations (e.g., uniform stator segment version). Referring to FIG. 6, performance of various versions of the DHAM configurations are shown in a graph plotting efficiency vs. power density measured in kW/L. In FIG. 6, the power density of the uniform stator design does not exceed 8 kW/L. On the other hand, the interleaved DHAM greatly surpassed the uniform DHAMs. Not only did the peak power density improved from 7.8 kW/L to 31.6 kW/L, the machine's efficiency also increased across the design space. In this comparison, it should be noted that the uniform stator DHAM's efficiency data did not include core losses whereas in the interleaved stator DHAM it is included. This is why the efficiency of the interleaved stator DHAM is only as good as the uniform versions at low peak power per volume ratios.

As discussed herein, the DHAM according to the present disclosure can be operated as a generator or as a motor. In each case, the DHAM of the present disclosure is coupled to an interface circuit adapted to operate the DHAM accordingly. The interface circuitry is coupled to each of the main windings of each stator segment. Additionally, the interface circuitry may also be coupled to each of the auxiliary windings, if energization of the auxiliary windings is desirable.

Those having ordinary skill in the art will recognize that numerous modifications can be made to the specific implementations described above. The implementations should not be limited to the particular limitations described. Other implementations may be possible.

1. A homopolar alternating current machine (HAM), comprising:
a stator having a body axially extending from a first end to a second end and further having a plurality of segments radially protruding outward from the body, each segment comprising
a main winding disposed centrally about the segment,
a first auxiliary winding disposed at a proximal end of the segment, and
a second auxiliary winding disposed at a distal end of the segment, whereby each of the first and second auxiliary windings are coupled to each other in a parallel manner;
a first rotor disposed proximate the first end of the stator;
a second rotor disposed proximate the second end of the stator; and
a dc flux source corresponding to each of the first and second rotors,
whereby substantially no excitation of the first and the second auxiliary windings of each stator segment of the plurality of segments is needed to operate the HAM,
whereby when energized, there is substantially no DC flux in each of the main winding,
wherein operating the HAM is associated with a substantially sinusoidal current waveform without a DC offset, and
wherein the HAM can be operated as a motor or a generator.

2. The HAM of claim 1, wherein the DC flux source associated with each of the first and second rotors is a permanent magnet.

3. The HAM of claim 2, wherein each permanent magnet includes at least some amount of heavy-rare-earth material.

4. The HAM of claim 3, wherein the heavy-rare-earth material is dysprosium.

5. The HAM of claim 2, wherein each permanent magnet is substantially free of heavy-rare-earth material.

6. The HAM of claim 5, wherein the non-heavy-rare-earth containing material is selected from the group consisting of Nd₂Fe₁₄B, SmCo₅, AlNiCo, ferrite, PtCo, MnAlC, and a combination of one or more thereof.

7. The HAM of claim 2, wherein each permanent magnet is coupled to the associated rotor and configured to rotate with the rotor.

8. The HAM of claim 2, wherein each permanent magnet is decoupled from the associated rotor and configured to remain stationary.

9. The HAM of claim 1, wherein the DC flux source associated with each of the first and second rotors is a field winding, disposed between the associated rotor and the body of the stator.

10. The HAM of claim 1, wherein the HAM is capable of generating a power density of about 32 kW/L at about 91% efficiency.

11. An alternating current (AC) system for operating a homopolar AC machine (HAM), comprising:
a HAM, comprising:
a stator having a body axially extending from a first end to a second end and further having a plurality of segments radially protruding outward from the body, each segment comprising
a main winding disposed centrally about the segment,
a first auxiliary winding disposed at a proximal end of the segment, and
a second auxiliary winding disposed at a distal end of the segment;
a first rotor disposed proximate the first end of the stator;
a second rotor disposed proximate the second end of the stator; and
a dc flux source corresponding to each of the first and second rotors,
whereby substantially no excitation of the first and the second auxiliary windings of each stator segment of the plurality of segments is needed to operate the HAM, and
whereby when energized, there is substantially no DC flux in each of the main windings, reducing magnetic cross section requirements (mass) and,
wherein operating the HAM is associated with a substantially sinusoidal current waveform without a DC offset;
an interface circuit coupled to the HAM, whereby the interface circuit is adapted to operate the HAM in one of a generator or a motor, wherein the interface circuit is coupled to each of the main windings.

12. The system of claim 1, wherein the DC flux source associated with each of the first and second rotors is a permanent magnet.

13. The system of claim 12, wherein each permanent magnet includes at least some amount of heavy-rare-earth material.

14. The system of claim 13, wherein the heavy-rare-earth material is dysprosium.

15. The system of claim 12, wherein each permanent magnet is substantially free of non-heavy-rare earth material.

16. The system of claim 15, wherein the non-heavy-rare-earth containing material is selected from the group consisting of Nd₂Fe₁₄B, SmCo₅, AlNiCo, ferrite, PtCo, MnAlC, and a combination of one or more thereof.

17. The system of claim 2, wherein each permanent magnet is coupled to the associated rotor and configured to rotate with the rotor.

18. The system of claim 2, wherein each permanent magnet is decoupled from the associated rotor and configured to remain stationary.

19. The system of claim 1, wherein the DC flux source associated with each of the first and second rotors is a field winding, disposed between the associated rotor and the body of the stator.

20. The system of claim 1, wherein the HAM is capable of generating a power density of about 32 kW/L at about 91% efficiency.
